(19) United States
(12) Patent Application Publication
(10) Pub. No.: US 2022/0161575 A1
(43) Pub. Date: May 26, 2022

(54) PLATEN ROLLER AND MANUFACTURING METHOD THEREOF

(71) Applicant: KINYOSHA CO., LTD., Tokyo (JP)

(72) Inventors: Tatsuya KITANAKA, Tokyo (JP); Kyohei EBATA, Tokyo (JP)

(21) Appl. No.: 17/527,996

(22) Filed: Nov. 16, 2021

(30) Foreign Application Priority Data
Nov. 20, 2020 (JP) 2020-193690

(51) Int. Cl. B41J 11/04; B41J 3/407

(52) U.S. Cl. CPC B41J 11/04; B41J 3/4075

(57) ABSTRACT

A platen roller for a label printer using a sticky label without a liner on the rear surface thereof, the platen roller includes a shaft body, a foaming elastic layer provided with an outer periphery of the shaft body, with a plurality of foaming cells opening on the surface thereof and a non-sticky layer provided with the outer peripheral surface of the foaming elastic layer, with asperities part corresponding to the opening foaming cells of the foaming elastic layer, the non-sticky layer in a non-ground state.

### CROSS-REFERENCE TO RELATED APPLICATIONS

This application is based upon and claims the benefit of priority from prior Japanese Patent Application No. 2020-193690, filed Nov. 20, 2020, the entire contents of which are incorporated herein by reference.

### BACKGROUND OF THE INVENTION

### 1. Field of the Invention

The present invention relates to a platen roller for a label printer.

### 2. Description of the Related Art

Label printers used to print a sticker or a label use a thermal print head as a printing method thereof, and there are thermal transfer type printers using an ink ribbon and heat-sensitive type printers using a label with a heat-sensitive color developing layer. In either case, the printing method utilizes a platen roller including an elastic body such as rubber provided with a shaft body thereof, which is arranged in the opposed surface of the thermal print head. With the platen roller, a label is conveyed to contact the thermal print head for printing.

The label used in the label printer includes a sticky layer and a liner in the rear surface of the substrate. When the label is used for adhesion, the liner is peeled off, and is disposed as a waste.

In recent years, from resource conservative and waste reduction standpoints, liner-less labels which have no liners are used. In the liner-less labels, a peeling layer is provided with the printing side of the substrate while a sticky layer is provided with the rear surface thereof, and the band-like body thereof is rolled such that the sticky layer overlaps with the peeling layer, and thus, the label can be used without a liner.

The label printer configured to print labels holds the label supplied from the rolled label in a supplier with the thermal print head and the platen roller, and rotates the platen roller for printing and conveying the label. After the printing, the label printer stops, and the label is held between the thermal print head and the platen roller, and is stopped while being pressed thereby. If the label does not have a liner, and a contacting state between the sticky layer of the label and the platen roller is maintained for a long time, the sticky agent may adhere to the platen roller, or the liner-less label may stick to the rotating platen roller when the printing is resumed, or a conveying direction may be changed, and thus, the label may not be issued properly.

As examples of methods of improving peeling force of the platen roller with respect to the liner-less label, Patent Literature 1 (JP 2013-049146 A), Patent Literature 2 (JP 2015-134481 A), Patent Literature 3 (JP 2000-296937 A), and Patent Literature 4 (JP 2013-193248 A) disclose a method of forming a plurality of grooves on the peripheral surface of the platen roller, and a method of forming asperity on the surface in order to decrease a contacting area between the sticky layer of the liner-less label and the platen roller.

### SUMMARY OF THE INVENTION

Note that, when grooves are formed in a platen roller as in Patent Literature 1, if the width of the groove is too wide, peeling of the label will be facilitated while printing may possibly be performed poorly since the pressing against the thermal print head in the part of the groove may become insufficient. On the other hand, if the width of the groove is narrowed but the number of grooves is increased to decrease the contacting area, the thickness of the elastic layer between the grooves contacting the liner-less label will be thinned, and thus, strength of the elastic layer in a direction of peeling the label may be decreased, and a possibility of breaking the platen roller in use will become high.

Patent Literature 2 proposes forming lattice-shaped diagonal concaves at predetermined intervals on the outer surface of a platen roller in order to maintain a gripping force and peeling characteristics with respect to labels. However, if lattice-shaped concaves are formed on the outer surface of the platen roller with a mold, the mold with protrusions corresponding to the concaves must be prepared, which is very expensive. Furthermore, if such concaves are formed on the outer surface of the platen roller in an after treatment, the treatment unit becomes very expensive. In addition, a treatment time becomes very long, and the production costs will become high.

Patent Literature 3 discloses a technique of forming asperity on the outer surface of a platen roller through applying a liquefied silicone rubber onto the outer surface of the platen roller, and then, pressing a mold to form protrusions before the rubber is cured, and heating the protrusion for the cure. However, in this method, the shapes of the protrusions tend to vary, and the heights of the protrusions may vary and the shapes thereof may be deformed because the rubber is pulled toward the mold side when the mold is peeled off from the platen roller.

Patent Literature 4 discloses forming asperity on the surface of a platen roller by introducing powder particles in a non-sticky coating. However, since the powder particles are hard, there will be a difference between the hardness of concave part and that of protrusion part. Furthermore, if a great amount of the powder particles is added, a ratio of rubber with respect to the powder particles decreases in the part where the powder particles are congregated, and thus, the part tends to be broken through repeated deformations caused by contacting to a thermal print head. Furthermore, the powder particle itself has a low peeling characteristic with respect to a sticky layer of a liner-less label, and if the powder particles are exposed on the outer surface of the platen roller by friction, the liner-less label tends to stick to the particles.

The present application presents a platen roller for a label printer configured to print a liner-less label with excellent conveying and printing characteristics while maintaining a proper peeling performance with respect to the liner-less label.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view of a platen roller of an embodiment.

FIG. 2 is a cross-sectional view of the platen roller of an embodiment.

### DETAILED DESCRIPTION OF THE INVENTION

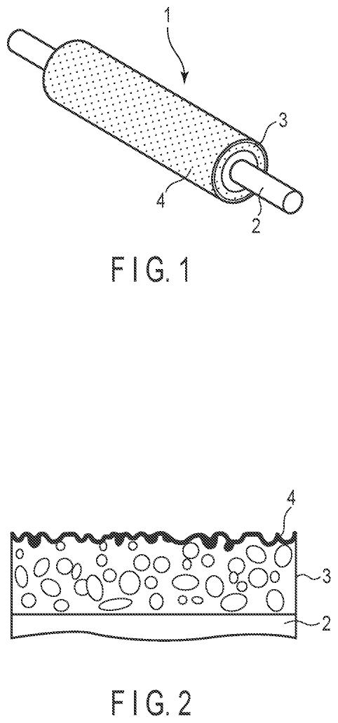

Hereinafter, a platen roller of an embodiment of the present application, and a manufacturing method of the same will be explained with reference to FIGS. 1 and 2. FIG. 1 is a perspective view of a platen roller of an embodiment, and FIG. 2 is a cross-sectional view of a foaming elastic layer and a non-sticky layer, depicted in an enlarged manner.

A platen roller 1 of an embodiment is provided with a label printer using a sticky label without a liner on the rear surface thereof, that is, a liner-less sticky label. The platen roller 1 includes a shaft body 2. A foaming elastic layer 3 is provided with an outer periphery of the shaft body 2 while a plurality of foaming cells are opened on the surface thereof. A non-sticky layer 4 in a non-ground state is provided with the outer peripheral surface of the foaming elastic layer 3, and having asperities corresponding to the foaming cells opening in the foaming elastic layer 3.

(Shaft Body)

The shaft body 2 is, for example, a cylindrical shaft body. A publically-known shaft body formed of a metal such as iron, aluminum, stainless, or the like can be used as the shaft body 2, for example.

(Foaming Elastic Layer)

The foaming elastic layer 3 is a foam containing elastomer with rubber elasticity, and including a large number of foaming cells therein.

The elastomer is, for example, NBR, EPDM, urethane rubber, or silicone rubber, or a combination of two or more of the aforementioned materials.

The outer peripheral surface of the foaming elastic layer 3 is ground to a predetermined dimension using a cylindrical grinder or the like, and at the same time, a plurality of foaming cells are opened on the outer peripheral surface.

An expansion ratio of the foaming elastic layer 3 is, preferably, set equal to or greater than 120% and equal to or less than 200%. If the expansion ratio is below 120%, the opening foaming cells on the surface of the foaming elastic layer 3 after the outer diameter grinding will become sparse. Thus, if the non-sticky layer 4 is provided with the outer peripheral surface of the foaming elastic layer 3, the degree of asperities on the outer surface of the non-sticky layer 4 decreases such that the outer surface becomes almost smooth, and the peeling characteristics of the liner-less label decrease.

On the other hand, if the expansion ratio exceeds 200%, the hardness of the foaming elastic layer 3 becomes low. Thus, deformation of the platen roller 1 caused by contacting to the thermal print head increases, and conveying and printing performances will be deteriorated.

The rubber material hardness of the foaming elastic layer is, preferably, equal to or greater than 50° and equal to or less than 70°. If the rubber material hardness of the foaming elastic layer 3 which is an elastic layer of the platen roller 1 is below 50°, the foaming elastic layer 3 has a low hardness, and thus, deformation thereof caused by contacting to the thermal print head increases. As a result, conveying of the liner-less label becomes unstable. Thus, the rubber material hardness is a hardness of cured material in a non-foamed state.

On the other hand, if the rubber material hardness of the foaming elastic layer 3 exceeds 70°, the foaming elastic layer 3 becomes too hard, and deformation thereof caused by contacting to the thermal print head becomes too small, a gripping force decreases, and slipping tends to occur.

The outer peripheral surface of the foaming elastic layer 3 has irregular asperities because of the foaming cells opening thereon. An average diameter of the foaming cells opening (average foaming cell diameter) is, preferably, equal to or greater than 100 μm and equal to or less than 300 μm. If the average diameter is below 100 μm, the surface of the non-sticky layer 4 formed on the outer peripheral surface of the foaming elastic layer 3 becomes smooth, and a contacting area with the liner-less label increases, and the peeling performance may possibly decrease.

On the other hand, if the average foaming cell diameter exceeds 300 μm, a difference between the hardness of the foamed part and the hardness of the non-foamed part increases, and pressure on the surface when contacting to the thermal print head may vary, and thus, the printing quality may possibly decrease. Note that, a more preferred average foaming cell diameter is equal to or greater than 130 μm and equal to or less than 200 μm.

Furthermore, the foaming elastic layer 3 may contain a silicone oil for increasing the peeling characteristics with respect to the liner-less label.

(Non-Sticky Layer)

The non-sticky layer 4 may be formed of a silicone rubber as a material with peeling characteristics. Such a silicone rubber is, for example, a thermal cured liquefied silicone rubber or a room-temperature cured liquefied silicone rubber. The density of the liquefied silicone rubbers is, preferably, equal to or greater than 0.97 g/cm³ and equal to or less than 1.30 g/cm³. If the density is below 0.97 g/cm³, reinforcing fillers contained therein becomes low, and the rubber hardness after the curing becomes low, and thus, it may be damaged during the use. On the other hand, if the density exceeds 1.30 g/cm³, a non-reinforcing fillers contained therein becomes greater, treatment thereof becomes difficult because the viscosity increases, and abrasion resistance may possibly decrease.

The non-sticky layer 4 is in the non-ground state. In this example, the non-ground state means that, after the non-sticky layer 4 is formed on the outer peripheral surface of the foaming elastic layer 3, the surface of the non-sticky layer 4 is not ground. Since the non-sticky layer 4 is in the non-ground state, the smooth asperity shape corresponding to the asperities formed by the foaming cells opening in the foaming elastic layer 3 can be maintained. Thus, a contacting area with the liner-less label can be decreased, and at the same time, the gripping force in the conveying time can be maintained.

An average thickness of the non-sticky layer 4 is, preferably, equal to or greater than 20 μm and equal to or less than 180 μm. If the average thickness of the non-sticky layer 4 is below 20 μm, applying the non-sticky layer 4 evenly on the outer peripheral surface of the foaming elastic layer 3 becomes difficult. Furthermore, since the outer peripheral surface of the non-sticky layer 4 does not become a smooth asperity shape, the gripping force may possibly decrease. Furthermore, the peeling characteristics by friction may possibly decrease. On the other hand, if the average thickness of the non-sticky layer 4 exceeds 180 μm, the outer peripheral surface of the non-sticky layer 4 does not correspond to the foaming cells opening on the outer peripheral surface of the foaming elastic layer, and becomes smooth, and thus, the peeling characteristics with respect to the sticky layer of the liner-less label may possibly decrease. Furthermore, a dimension accuracy required for the platen roller 1 decreases, and the liner-less label may possibly meander in the conveying time.

The arithmetic average roughness Ra of the non-sticky layer 4 is, preferably, equal to or greater than 3 μm and equal to or less than 20 μm. If the arithmetic average roughness Ra of the non-sticky layer 4 is below 3 μm, the contacting area of the non-sticky layer 4 with respect to the sticky layer of the liner-less label becomes greater, and the peeling characteristics with respect to the liner-less label decreases, and thus, the liner-less label may possibly be tangled in the platen roller 1. On the other hand, if the arithmetic average roughness Ra of the non-sticky layer 4 exceeds 20 μm, the contacting area between the liner-less label and the platen roller 1 becomes too small, slipping tends to occur.

The platen roller of the present embodiment includes a foaming elastic layer with a plurality of foaming cells opening on the surface thereof, and a non-sticky layer in a non-ground state, which is provided with the outer peripheral surface of the foaming elastic layer with an asperity part corresponding to the foaming cells opening on the foaming elastic layer, and thus, the platen roller exerts non-stickiness while the roller itself has the asperity part which exerts excellent peeling characteristics with respect to the sticky surface of the liner-less label. Furthermore, if the platen roller is pressed, the foaming elastic layer changes the volume with respect to the pressure applied in the thickness direction by the foaming cells, the asperity shape on the surface of the non-sticky layer can be maintained. As a result, the non-sticky layer contacting the sticky surface of the liner-less label indicates high peeling characteristics when printing is performed on the liner-less label, and thus, the liner-less label can be smoothly conveyed, printing can be performed properly, and the liner-less label can be stably printed. Furthermore, friction and damage to the foaming elastic layer in the printing process are suppressed, and the life of the plate roller can be prolonged.

If the elastic layer of the platen roller is a non-foamed solid, both ends are deformed in the axis direction in the grinding treatment, and thus, the outer diameter increases from the proximity of the center of the axis toward the ends. This may influence on the conveying performance, and thus, a tapering treatment or the like must be performed on the ends.

The platen roller of the present embodiment includes a foam elastic layer which can change the volume in the thickness direction even if the outer diameter of the ends increases. Thus, when printing on the liner-less label, stable conveying performance can be achieved.

Now, a manufacturing method of the platen roller of the embodiment will be explained.

Initially, a foaming elastic layer is formed in a shaft body.

In the forming of the foaming elastic layer, a polymer material which is an elastomer is prepared, and then, additives such as a curing agent, foaming agent, and pigment are added thereto to prepare a rubber composition. The shaft body is covered with the rubber composition through, for example, extrusion molding. Then, for example, the rubber composition is heated in an oven, and is cured to be foamed, and furthermore, post curing is performed thereto in order to form the foaming elastic layer on the shaft body.

Note that, the formation of the foaming elastic layer is not limited to a method of using the rubber composition, and several other methods as follows can be adopted. In one method, a liquefied elastomer is stirred while air is mixed thereto until microbubbles are contained therein, and then, the elastomer is charged in a cylindrical mold in which a shaft body is set therein, and the elastomer is heated to be cured. In another method, a rubber composition of a liquefied elastomer and hollow fillers covered with thermoplastic resin outer shells, and the rubber composition is charged in a cylindrical mold in which a shaft body is set therein, and the rubber composition is heated to be cured. In another method, a liquefied elastomer, incompatible liquid, and surfactant are mixed and stirred to prepare an emulsion composition, the emulsion composition is charged in a cylindrical mold in which a shaft body is set, and the emulsion composition is heated to be cured in a temperature which is below the boiling point of the incompatible liquid, and then, is heated in a temperature which is above the boiling point of the incompatible liquid to remove the liquid.

Then, both ends of the foaming elastic layer obtained in the above are cut to a desired length. Then, the outer peripheral surface of the foaming elastic layer is ground to a desired outer diameter. Through the grinding treatment, a plurality of foaming cells are opened on the outer peripheral surface, and desired asperities are formed.

Then, a liquefied silicone rubber which is a of a non-sticky layer is applied onto the outer peripheral surface of the forming elastic layer. The liquefied silicone rubber may contain an additive such as a pigment.

The viscosity of the silicone rubber is, preferably, equal to or greater than 10 Pa·s and equal to or less than 500 Pa·s. If the viscosity of the silicone rubber is below 10 Pa·s, when the non-sticky layer is formed, the thickness of the coating layer varies, and the dimension accuracy required for the platen roller may not be satisfied. On the other hand, if the viscosity of the silicone rubber exceeds 500 Pa·s, forming the outer peripheral surface of the non-sticky layer corresponding to the asperity of the foaming cells opening on the outer peripheral surface of the foaming elastic layer becomes difficult. If the viscosity of the silicone rubber exceeds 500 Pa·s, the viscosity thereof in the application time may be adjusted using an organic solvent. However, in consideration of processability and environmental effects, the silicone rubber viscosity of which is equal to or greater than 10 Pa·s and equal to or less than 500 Pa·s is preferred since an organic solvent is not necessary.

The application of the raw material will be performed through several methods as follows.

(1) A ring coating method in which a raw material is preliminarily applied to an outer peripheral surface of a foaming elastic layer, and the foaming elastic layer is passed through a dice inner diameter of which is processed to correspond to the end product outer diameter of the platen roller in order to coat the raw material in a desired thickness onto the outer peripheral surface of the foaming elastic layer.

(2) A spray coating method in which a raw material is diluted in an organic solvent, and is sprayed onto the outer peripheral surface of the foaming elastic layer by a spray gun while the shaft body thereof is rotated.

(3) A method in which the raw material is applied preliminarily on a flat plate, and a foaming elastic layer is rolled onto the raw material applied on the flat plate such that the raw material can be transferred to the outer peripheral surface of the foaming elastic layer.

(4) A rotation application method in which metal plates are fixed with respect to the outer peripheral surface of a foaming elastic layer at certain intervals, and the raw material is introduced between the foaming elastic layer and the metal plates while the shaft body of the foaming elastic layer is rotated to apply the raw material onto the outer peripheral surface of the foaming elastic layer.

From the above application methods, the ring coating method is preferred because accuracy of dimension and easy treatability required for the platen roller.

After a coating film of silicone rubber is formed on the outer peripheral surface of the foaming elastic layer, the coating film is heated and cured by being set in a furnace heated to, for example, 80 to 180° C. for 10 minutes to 2 hours. If necessary, a post curing at 150 to 250° C. for 2 to 10 hours may be performed to form a non-sticky layer in a non-ground state, and thus, the platen roller is manufactured.

Through the manufacturing method of the platen roller of the present embodiment, the asperity part can be formed on the outer peripheral surface of the platen roller without using a specifically shaped mold. Thus, platen rollers can be manufactured at low costs without using expensive manufacturing equipments.

Furthermore, the asperity part is formed by grinding the outer peripheral surface of the foaming elastic layer such that a plurality of foaming cells are opened thereon. Thus, conditions such that the outer peripheral surface of the platen roller would partially include protrusions, and the shape would become uneven as in a conventional method can be solved. As a result, the non-sticky layer can be stably formed on the outer peripheral surface of the foaming elastic layer with an asperity shape corresponding to the foaming cells opening on the outer peripheral surface.

### EXAMPLES

Now, examples of the present invention will be explained. Note that the present invention is not at all limited to the examples.

In tests, a platen roller was prepared such that the hardness of a foaming elastic layer is set to axial Asker C hardness becomes 55 to 65° at 1 kg.

### Example 1

Primer No. 33 (Shin-Etsu Chemical Co., Ltd.) was applied to the surface of a shaft body (5 mm in diameter, 120 mm in length, SUS303).

Then, silicone rubber compounds KE-904F-U (Shi-Etsu Chemical Co., Ltd., 45° in hardness, 1.15 in density) and KE-7170-U (Shin-Etsu Chemical Co., Ltd., 70° in hardness, 1.18 in density) were mixed at 80:20 ratio, and thereby a silicone rubber blended compound (rubber material: 50° in hardness) was prepared. With respect to 100 parts by weight of rubber material, 3 parts by weight of dicumyl peroxide as a curing agent, 0.5 part by weight of finely crushed azobisisobutyronitrile (AIBN) as a foaming agent, and one part by weight of iron oxide paste as a pigment were added, and the silicone rubber blended compound was kneaded and mixed with an open roll to prepare a silicone rubber composition.

Then, an extrusion molding device was used to perform integral extrusion molding of the shaft body and the silicone rubber composition, and the silicone rubber composition was formed cylindrically on the outer periphery of the shaft body.

Then, the shaft body covered with the silicone rubber composition cylindrically applied onto the outer periphery thereof is heated in an oven at 200° C. for an hour for curing and foaming, and post curing was performed in the oven at 200° C. for four hours to prepare a foam silicone rubber.

Then, the both ends of the foam silicone rubber were cut to set the length to 87 mm, and the outer diameter of the foam silicone rubber was ground to 13 mm by a cylindrical polisher, and the foaming elastic layer was formed on the outer periphery of the shaft body.

Then, 100 parts by weight a liquefied silicone rubber SE6744 (Dow Corning Toray Co., LTD. The current name is Dupon-Toray-Special-Materials K.K., 40° in hardness, 1.12 in density, 150 Pa·s in viscosity), and one part by weight of iron oxide paste as a pigment were mixed and stirred to prepare a liquefied silicone rubber material. The liquefied silicone rubber material was applied onto the outer peripheral surface of the foaming elastic layer by a ring coating method. Then, it is heated at 150° C. for thirty minutes to be cured to prepare a non-sticky layer, and thereby, a platen roller was manufactured.

The foaming elastic layer of the platen roller manufactured above exerted an expansion ratio of 136%, average foaming cell diameter of 179 μm, average thickness of the non-sticky layer of 77 μm, and arithmetic average roughness Ra of 7.60 μm.

### Example 2

Silicone rubber compounds KE-904F-U (Shi-Etsu Chemical Co., Ltd., 45° in hardness, 1.15 in density) and KE-7170-U (Shin-Etsu Chemical Co., Ltd., 70° in hardness, 1.18 in density) were mixed as in Example 1 at 40:60 ratio, and thereby a silicone rubber blended compound (rubber material: 60° in hardness) was prepared. A foaming elastic layer was prepared using a silicone rubber composition with 1.5 parts by weight of resin microballoon FN-100MD (Matsumoto Yushi-Seiyaku Co., Ltd.) added as a foaming agent, and other than the above, a platen roller was prepared through the same method as in Example 1.

The foaming elastic layer of the platen roller manufactured above exerted an expansion ratio of 171%, average foaming cell diameter of 131 μm, average thickness of the non-sticky layer of 63 μm, and arithmetic average roughness Ra of 4.63 μm.

### Example 3

With respect to 100 parts by weight of KE-7170-U of Example 1 (rubber material: 70° in hardness), 0.6 parts by weight of AIBN was added, and such a silicone rubber composition was used to prepare a foaming elastic layer, and an average thickness of a non-sticky layer was set to 54 μm, and other than the above, a platen roller was prepared through the same method as in Example 1.

The foaming elastic layer of the platen roller manufactured above exerted an expansion ratio of 162%, average foaming cell diameter of 218 μm, and arithmetic average roughness Ra of 8.85 μm.

### Example 4

Silicone rubber compounds KE-904F-U (Shi-Etsu Chemical Co., Ltd., 45° in hardness, 1.15 in density) and KE-7170-U (Shin-Etsu Chemical Co., Ltd., 70° in hardness, 1.18 in density) were mixed as in Example 1 at 40:60 ratio, and thereby a silicone rubber blended compound (rubber material: 60° in hardness) was prepared. A foaming elastic layer was prepared using a silicone rubber composition with 1.5 parts by weight of resin microballoon FN-100MD (Matsumoto Yushi-Seiyaku Co., Ltd.) added as a foaming agent, and an average thickness of a non-sticky layer was set to 44 μm. Other than the above, a platen roller was prepared through the same method as in Example 1.

The foaming elastic layer of the platen roller manufactured above exerted an expansion ratio of 171%, average foaming cell diameter of 131 μm, and arithmetic average roughness Ra of 10.10 μm.

### Example 5

Silicone rubber compounds KE-904F-U (Shi-Etsu Chemical Co., Ltd., 45° in hardness, 1.15 in density) and KE-7170-U (Shin-Etsu Chemical Co., Ltd., 70° in hardness, 1.18 in density) were mixed as in Example 1 at 40:60 ratio, and thereby a silicone rubber blended compound (rubber material: 60° in hardness) was prepared. A foaming elastic layer was prepared using a silicone rubber composition with 0.5 parts by weight of uncrushed AIBN added as a foaming agent, and an average thickness of a non-sticky layer was set to 149 μm. Other than the above, a platen roller was prepared through the same method as in Example 1.

The foaming elastic layer of the platen roller manufactured above exerted an expansion ratio of 169%, average foaming cell diameter of 272 μm, and arithmetic average roughness Ra of 4.78 μm.

### Comparative Example 1

A foaming elastic layer was not formed on the outer periphery of the shaft body, but only a non-sticky layer was formed, and the outer diameter of the non-sticky layer was ground by a cylindrical polisher to 13 mm, and a platen roller was manufactured.

The platen roller manufactured above exerted an arithmetic average roughness Ra of 1.71 μm.

### Comparative Example 2

A foaming elastic layer was not formed on the outer periphery of the shaft body, but only a non-sticky layer was formed, and the outer diameter of the non-sticky layer was ground by a cylindrical polisher to 13 mm, and furthermore, grooves of 0.5 mm in width and 1 mm in pitch were formed on the outer surface of the non-sticky layer in a direction orthogonal to the axis direction thereof, and a platen roller was manufactured.

The platen roller manufactured above exerted an arithmetic average roughness Ra of 53.20 μm.

### Comparative Example 3

A foam silicone rubber was prepared as in Example 1, and the outer diameter thereof is ground to 12 mm, and a foaming elastic layer was formed on the outer periphery of the shaft body. The foaming elastic layer and the shaft body were together inserted into a cylindrical mold having an inner diameter of 14 mm, a liquefied silicone rubber material as in Example 1 was filled between the foaming elastic layer and the cylindrical mold, which was heated and cured at 150° C. for an hour. Then, the cured layer on the shaft body was extracted from the mold, the outer diameter of the non-sticky layer was ground by a cylindrical grinding machine to 13 mm, and a platen roller was manufactured.

The foaming elastic layer of the platen roller manufactured above exerted an expansion ratio of 136%, average foaming cell diameter of 179 μm, average thickness of the non-sticky layer of 615 μm, and arithmetic average roughness Ra of 1.66 μm.

The platen rollers manufactured as above were evaluated based on the following method.

(Rubber Material Hardness of Foaming Elastic Layer)

The rubber material hardness of the foaming elastic layer was measured by pressing the rubber composition excluding the foaming agent into a specimen having a thickness of 6 mm or more, and the specimen was measured, based on JIS K6253, using a type A durometer (Kobunshi Keiki Co., Ltd.).

(Expansion Ratio)

The expansion ratio of the foaming elastic layer was calculated by measuring a density of the rubber material after curing and a density of rubber after foamed by curing through an in-liquid weighing method, and applying the measured density values to the following formula.

Expansion ratio (%)=Density of rubber material after curing÷Density of rubber after foamed by curing×100.

(Average Foaming Cell Diameter)

On the outer surface of the foaming elastic layer before the non-sticky layer is formed, hollow parts of ten arbitrary foaming cells were measured using a laser microscope VK-9510 (Keyence Corporation), and the maximum lengths of the hollow parts were set as cell diameters. An average of the cell diameters was set as an average foaming cell diameter of the foaming elastic layer.

(Average Thickness of Non-Sticky Layer)

In a cross-sectional surface cut orthogonally to the axis direction of the platen roller, distances from ten arbitrary points on the outer surface to the foaming elastic layer surface were measured by a microscope VHX-700F (Keyence Corporation), and an average of the distances was set as an average thickness of the non-sticky layer.

(Arithmetic Average Roughness Ra)

The arithmetic average roughness of the non-sticky layer was measured along the axis direction of the platen roller by a surface roughness meter SE1799a (Kosaka Laboratory Ltd.). In this example, based on JIS B0601-2001, the arithmetic average roughness Ra was measured in the following condition.

### Condition

Stylus: Tip curvature radius 2 μm

Measurement speed: 0.1 mm/sec

Cutoff wavelength λc: 0.8 mm

Filter: Gaussian

Evaluation length: 4 mm

(Peeling force)

A peeling force of the platen roller with respect to the liner-less label was measured as follows.

Both axes of the platen roller were attached to a jig which can fix the both axes such that an opposite surface of the platen roller fixation side is connected to load cells. Fixation is performed such that the sticky layer of the liner-less label becomes a contacting surface to the platen roller, and a peak weight measured when the platen roller is pressed to the sticky layer at 2 kg for one minute, and then, peeled off from the label at 3 mm/min as the peeling force.

When the value of the peeling force increases, the liner-less label tends to stick to the platen roller, and thus, a lower measurement value of the peeling force is preferred.

(Evaluation of Printing and Conveying Performance)

The manufactured platen rollers were incorporated into the label printer to print liner-less labels, and a lack of printed image, and conveying performance of the labels were evaluated as follows.

(Printing Evaluation)

◯: No abnormality was observed by human eyes in printed image

x: Error was observed in printed image and cannot be recognized

(Conveying Performance Evaluation)

◯: Liner-less label was conveyed without stacking to or slipping on platen roller

Δ: Sticking to platen roller did not occur while change of ejection direction (angle) of liner-less label occurred

x: Stacking to, slipping on, or cut of platen roller occurred

Table 1 shows results of the above evaluations.

TABLE 1

| | | Example 1 | Example 2 | Example 3 | Example 4 | Example 5 |
|---|---|---|---|---|---|---|
| Rubber material | Durometer | 50 | 60 | 70 | 60 | 60 |
| hardness of | A | | | | | |
| foaming elastic layer | | | | | | |
| Average foaming | μm | 179 | 131 | 218 | 131 | 272 |
| cell diameter | | | | | | |
| Expansion ratio | % | 136 | 171 | 162 | 171 | 169 |
| Non-sticky layer | μm | 77 | 63 | 54 | 44 | 149 |
| average thickness | | | | | | |
| Arithmetic average | μm | 7.60 | 4.63 | 8.85 | 10.10 | 4.78 |
| roughness Ra | | | | | | |
| Test result | | | | | | |
| Peeling force | N | 0.02 | 0.02 | 0.02 | 0.02 | 0.01 |
| Printing evaluation | | ∘ | ∘ | ∘ | ∘ | ∘ |
| Conveying | | ∘ | ∘ | ∘ | ∘ | ∘ |
| performance | | | | | | |
| evaluation | | | | | | |

| | | Comparative | Comparative | Comparative |
|---|---|---|---|---|
| | | example 1 | example 2 | example 3 |
| Rubber material | Durometer A | — | — | 50 |
| hardness of | | | | |
| foaming elastic layer | | | | |
| Average foaming | μm | — | — | 179 |
| cell diameter | | | | |
| Expansion ratio | % | — | — | 136 |
| Non-sticky layer | μm | — | — | 615 |
| average thickness | | | | |
| Arithmetic average | μm | 1.71 | 53.20 | 1.66 |
| roughness Ra | | | | |
| Test result | | | | |
| Peeling force | N | 1.60 | 0.54 | 2.03 |
| Printing evaluation | | ∘ | x | ∘ |
| Conveying | | x | Δ | x |
| performance | | | | |
| evaluation | | | | |

As can be understood from Table 1, the platen rollers of Examples 1 to 5 indicated excellent peeling characteristics with respect to the liner-less labels, and also excellent conveying and printing performances.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A platen roller for a label printer using a sticky label without a liner on the rear surface thereof, the platen roller comprising:
a shaft body;
a foaming elastic layer provided with an outer periphery of the shaft body, with a plurality of foaming cells opening on the surface thereof; and
a non-sticky layer in a non-ground state provided with the outer peripheral surface of the foaming elastic layer, with asperities corresponding to the opening foaming cells of the foaming elastic layer.

2. The platen roller of claim 1, wherein the surface of the non-sticky layer in the non-ground state has an arithmetic average roughness Ra is equal to or greater than 3 μm and equal to or less than 20 μm.

3. The platen roller of claim 1, wherein the non-sticky layer in the non-ground state is a silicone rubber having an average thickness which is equal to or greater than 20 μm and equal to or less than 180 μm.

4. The platen roller of claim 1, wherein the foaming elastic layer having an average foaming cell diameter which is equal to or greater than 100 μm and equal to or less than 300 μm.

5. A manufacturing method of a platen roller for a label printer using a sticky label without a liner on the rear surface thereof, the method comprising:
forming a foaming elastic layer on an outer periphery of a shaft body;
performing grinding treatment to the outer peripheral surface of the foaming elastic layer to open a plurality of foaming cells on the outer peripheral surface; and
applying a silicone rubber on the ground outer peripheral surface of the foaming elastic layer and curing the silicone rubber to form a non-sticky layer in a non-ground state, with asperities corresponding to the opening foaming cells of the foaming elastic layer.
